(19) United States
(12) Patent Application Publication
(10) Pub. No.: US 2026/0361812 A1
(43) Pub. Date: Nov. 12, 2026

(54) Mobile Terminal Protective Case

(71) Applicant: PGYTECH CO.,LTD, Jiangsu (CN)

(72) Inventors: Xiuzhi YU, Jiangsu (CN); Xiao HU, Jiangsu (CN)

(73) Assignee: PGYTECH CO.,LTD, Jiangsu (CN)

(21) Appl. No.: 19/438,459

(22) Filed: Dec. 31, 2025

(30) Foreign Application Priority Data
May 12, 2025 (CN) 2025209263523

(51) Int. Cl. H04M 1/02

(52) U.S. Cl. CPC H04M 1/0203

(57) ABSTRACT

The present disclosure relates to a mobile terminal protective case, comprising a frame, a back plate and a locking pin mechanism. The back plate is detachably arranged on the frame to form an accommodating cavity for housing a mobile terminal; the locking pin mechanism comprises at least two locking pins, which are elastically arranged on at least one of the frame and the back plate, and the locking pins have a locked position and an unlocked position.

### CROSS-REFERENCE TO RELATED APPLICATIONS

This application claims priority to Chinese Utility Model Application No. 2025209263523, filed on May 12, 2025, entitled “Mobile Terminal Protective Case”, the content of which, including the amendment thereof, is incorporated into this application by reference in its entirety.

### TECHNICAL FIELD

The present disclosure relates to the technical field of protective cases, particularly to a mobile terminal protective case.

### BACKGROUND

In related technologies, protective cases provided for mobile terminals such as mobile phones and tablet computers come in various forms, which can generally be categorized into flexible protective cases and rigid protective cases based on material properties.

One type of protective case is made from flexible materials such as silicone or TPU. These materials inherently possess certain elasticity and resilience, allowing the protective case to be integrally formed as a “slip-on” structure. During assembly, users can press the mobile terminal into the interior of the case through the material's elasticity, enabling the case to envelop and secure the peripheral edges of the mobile terminal. Relying on material elasticity for assembly and locking, such protective cases are typically easy to install and remove, and significant gaps between the case and the mobile terminal are unlikely to occur.

Another type of protective case is made from rigid materials such as plastic, metal, or composite materials. Compared to flexible materials, rigid materials offer advantages like high strength, good wear resistance, and superior aesthetic texture, making them widely used in mobile terminal protection scenarios requiring higher impact resistance or appearance standards. However, rigid materials generally lack sufficient elastic deformation capability. If the protective case is entirely fabricated as a one-piece structure, it may be difficult to smoothly insert the mobile terminal during assembly due to insufficient opening of the case, or significant external force may be required to forcibly pry open the case, potentially leading to deformation, cracking of the case, or even damage to the mobile terminal. To balance assembly feasibility and structural strength, rigid protective cases in related technologies often adopt a split structure, dividing the case into a frame and a back plate that are formed separately, then assembled to achieve enveloping protection for the mobile terminal. Typically, the frame is used to envelop the side edges and corner areas of the mobile terminal, while the back plate covers the back of the mobile terminal; during assembly, the mobile terminal is first placed into the frame, and then the back plate is connected to the frame, allowing the two to enclose and form an accommodating cavity for housing the mobile terminal.

However, the aforementioned split structure still presents notable reliability issues in practical use. Since the frame and back plate need to achieve detachable connection, related technologies typically employ methods such as snaps, plugs, clips, screw fastening, or magnetic attraction to complete their connection. Among these, snap or plug-type structures are susceptible to factors like manufacturing tolerances, material shrinkage and deformation, long-term wear, and repeated disassembly, often leading to gradually increasing fit gaps and reduced snap force. While screw fastening offers relatively firm connection, it involves cumbersome disassembly steps, high user operation costs, and is not conducive to frequent back plate replacement. Magnetic attraction, although convenient for disassembly, may lack stability as magnetic force is affected by structural dimensions, magnet specifications, metal interference, and impact from drops. Especially during daily carrying, gripping, drop impacts, or compression of the mobile terminal, the connection area between the frame and back plate often endures repeated pulling, twisting, or impact forces. If the connection structure's resistance to loosening is insufficient, issues such as local warping, loosening, or even complete detachment of the back plate can easily occur.

When the back plate loosens or detaches from the frame, the protective case's coverage of the mobile terminal's back and edges is compromised, weakening the positional constraint of the mobile terminal within the accommodating cavity. In mild cases, this can cause the mobile terminal to wobble inside the case, produce abnormal noises, and degrade the handling feel. In severe cases, during drops or vigorous shaking, the mobile terminal may accidentally slide out of the protective case, significantly increasing the risk of impact damage to areas such as the screen, corners, or camera module, thereby affecting the safety and reliability of the mobile terminal's use.

Therefore, for hard split-type mobile terminal protective cases, how to ensure the convenience of detachable assembly while enhancing the stability of the connection between the back plate and frame, reducing the probability of accidental back plate detachment, and further improving the assembly reliability of the mobile terminal within the protective case has become a technical problem urgently needing resolution in related technologies.

### SUMMARY

The present disclosure provides a mobile terminal protective case to address the issues raised in the above background technology.

To achieve the above object, the present disclosure adopts the following technical solutions:

A mobile terminal protective case includes a frame; a back plate detachably arranged on the frame to form an accommodating cavity for housing a mobile terminal; and a locking pin mechanism, including at least two locking pins elastically arranged on at least one of the frame and the back plate, and the locking pins have a locked position and an unlocked position. When no external force is applied to the locking pins, the locking pins are capable of moving to the locked position under an elastic action and being engaged with the other of the frame and the back plate; and when an external force is applied to the locking pins to overcome the elastic action and move the locking pins to the unlocked position, the locking pins are separated from the other of the frame and the back plate.

The present disclosure further provides a technical solution: a mobile terminal protective case, including a frame; a back plate detachably connected to the frame to cooperate with the frame to define an accommodating cavity for accommodating a mobile terminal; and a pair of locking assemblies arranged on the frame. Each locking assembly includes: a slide groove provided on the frame, the slide groove having an open notch facing the back plate; locking pin components slidably accommodated within the slide groove and movable between a locked position and an unlocked position; a spring arranged within the slide groove, elastically biasing the locking pin components to the locked position; and a toggle component coupled to the locking pin components and operable from outside the frame through an elongated hole formed on an outer side of the frame. The back plate includes a snap hook insertable into the slide groove through the open notch. When the locking pin components are in the locked position, the locking pin component are engaged with the snap hook to retain the back plate on the frame, and when the locking pin components are in the unlocked position, the locking pin components disengage from the snap hook to allow separation of the back plate from the frame. A pair of locking pin components are configured to move closer to each other when driven to the unlocked position.

The beneficial effects of the present disclosure compared to the prior art are: the mobile terminal protective case of this application reliably locks the back plate through at least two elastic locking pins, and cooperates with the positioning structure of the insertion end, the unlocking structure of the toggle component, and the auxiliary lifting structure of the second elastic component, thereby improving the connection stability between the back plate and the frame while ensuring ease of assembly and disassembly, effectively reducing the risk of accidental detachment of the back plate and unintended removal of the mobile terminal.

### BRIEF DESCRIPTION OF DRAWINGS

The drawings, which form a part of this application, are provided to further illustrate the present disclosure. The illustrative embodiments and the descriptions thereof are intended to explain the present disclosure and do not constitute an improper limitation thereof. In the drawings:

FIG. 1 is a schematic structural diagram of a mobile terminal and a mobile terminal protective case according to an embodiment of the present disclosure;

FIG. 2 is a schematic structural diagram of the mobile terminal protective case from a first perspective according to an embodiment of the present disclosure;

FIG. 3 is a schematic structural diagram of a mobile terminal protective case in a second viewing angle according to an embodiment of the present disclosure;

FIG. 4 is an enlarged view of part IV in FIG. 3;

FIG. 5 is a schematic structural diagram of a frame and a locking pin mechanism according to an embodiment of the present disclosure;

FIG. 6 is an enlarged view of part VI in FIG. 5;

FIG. 7 is an exploded schematic structural diagram of a mobile terminal protective case in a first viewing angle according to an embodiment of the present disclosure;

FIG. 8 is an exploded schematic structural diagram of a mobile terminal protective case in a second viewing angle according to an embodiment of the present disclosure;

FIG. 9 is an exploded schematic structural diagram of a frame and a locking pin mechanism according to an embodiment of the present disclosure;

FIG. 10 is an enlarged view of part X in FIG. 9;

FIG. 11 is a schematic structural diagram of a mobile terminal protective case in a third viewing angle according to an embodiment of the present disclosure;

FIG. 12 is a cross-sectional view taken along line A-A in FIG. 11;

FIG. 13 is an exploded schematic structural diagram of a mobile terminal protective case in a third viewing angle according to an embodiment of the present disclosure;

FIG. 14 is an enlarged view of part XIV in FIG. 13;

FIG. 15 is a schematic structural diagram of a back plate and a second elastic component according to an embodiment of the present disclosure;

FIG. 16 is an enlarged view of part XVI in FIG. 5;

FIG. 17 is a schematic diagram showing the position of a positioning groove on a mobile terminal protective case according to an embodiment of the present disclosure;

FIG. 18 is a schematic structural diagram of a mobile terminal protective case, a quick-release component, and a handle according to an embodiment of the present disclosure;

FIG. 19 is a schematic diagram of the overall structure of another embodiment provided by the present disclosure;

FIG. 20 is an exploded schematic diagram of the mobile terminal protective case in the embodiment provided in FIG. 19 from a first perspective;

FIG. 21 is an exploded schematic diagram of the mobile terminal protective case in the embodiment provided in FIG. 19 from a second perspective;

FIG. 22 is a schematic diagram of the internal structure of the sliding cavity in the embodiment provided in FIG. 19;

FIG. 23 is a schematic diagram of the overall structure of another embodiment provided by the present disclosure;

FIG. 24 is an exploded schematic diagram of the mobile terminal protective case in the embodiment provided in FIG. 23 from a first perspective;

FIG. 25 is a schematic diagram of the structure at location A in FIG. 24;

FIG. 26 is a schematic diagram of the structure when the front cover is ready for installation in the embodiment provided in FIG. 24.

Reference signs: 010—Mobile Terminal Protective Case; 100—Frame; 101—Slide Groove; 102-Elongated Hole; 103—Relief Groove; 104—First Stepped Surface; 105—First Through Hole; 106-Second Through Hole; 110—First Side Edge; 120—Second Side Edge; 130—Third Side Edge; 131—Slot; 132-Slot Wall; 140—Fourth Side Edge; 200—Back Plate; 210—Back Plate Body; 220—Snap Hook; 230-Insertion Protrusion; 300—Mobile Terminal; 400—Locking Pin Mechanism; 410—Locking Pin; 411—Second Stepped Surface; 420—First Elastic Component; 430—Toggle Component; 510-Rubber Pad; 511—Rubber Pad Body; 512—Projection; 520—Second Elastic Component; 530—Lanyard Pin; 540—Touch Module; 550—Positioning Groove; 600—Quick-Release Component; 700—Handle; 800—Sliding Cavity; 810—Sliding Plate; 820—Clamping Groove; 830—Third Elastic Component; 900—Front Cover; 910—Insertion Slot; 920—Slide Rail; A—First Direction; B—Second Direction; C—First Set Direction; D—Second Set Direction.

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, equipment, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

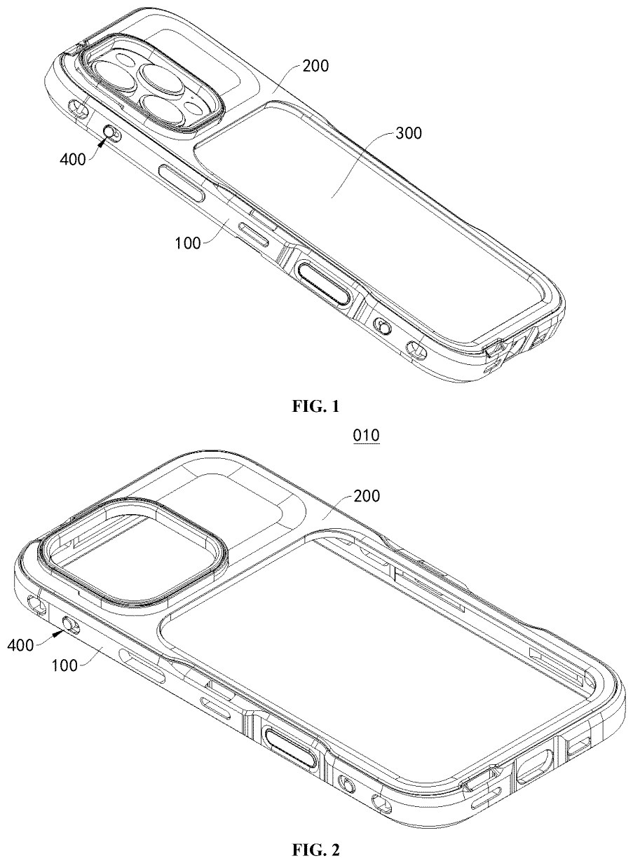

Please refer to FIGS. 1 to 4. This embodiment provides a mobile terminal protective case 010, which can be used to cover and protect mobile terminals 300 such as mobile phones and tablets. The mobile terminal protective case 010 includes a frame 100 and a back plate 200 detachably connected to the frame 100. When the back plate 200 is connected to the frame 100, the back plate 200 and the frame 100 together enclose an accommodating cavity for housing the mobile terminal 300.

Since the back plate 200 and the frame 100 are detachably connected, during assembly, the frame 100 can first be fitted around the periphery of the mobile terminal 300 to position and protect the circumferential edges of the mobile terminal 300. Then, the back plate 200 is connected to the frame 100, covering the back of the mobile terminal 300, thereby completing the enclosure of the mobile terminal 300 by the protective case 010. Correspondingly, when the mobile terminal 300 needs to be removed, the back plate 200 can first be detached from the frame 100, and then the mobile terminal 300 can be taken out from the frame 100.

The above split structure can balance the strength of a rigid protective case with assembly operability, but it may also lead to the back plate 200 loosening or even detaching due to insufficient reliability of the connection structure, thereby risking accidental dropping of the mobile terminal 300. To address this, this embodiment improves the connection method between the back plate 200 and the frame 100 to enhance connection stability and ease of disassembly and assembly.

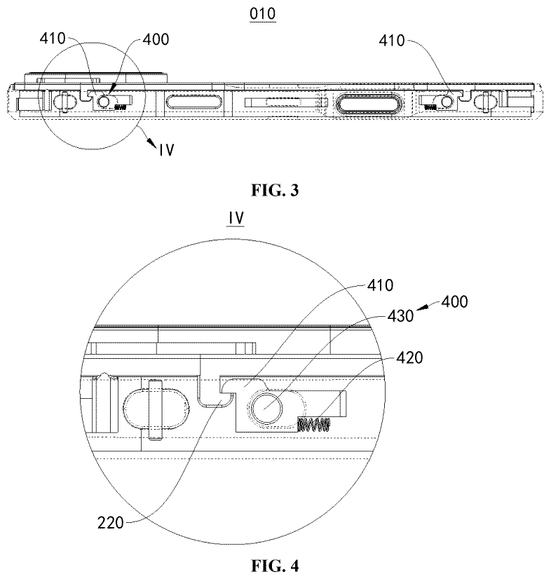

Specifically, referring to FIGS. 3 and 4, the mobile terminal protective case 010 further includes a locking pin mechanism 400. The locking pin mechanism 400 includes at least two locking pins 410, which are elastically mounted on the frame 100, and each locking pin 410 has a locked position and an unlocked position: when no external force acts on the locking pin 410, it can move to the locked position under elastic force and engage with the back plate 200, securely connecting the back plate 200 to the frame 100 through the locking pin 410; when the locking pin 410 overcomes the elastic force under external force and moves to the unlocked position, the locking pin 410 separates from the back plate 200, allowing the back plate 200 to be detached from the frame 100.

By locking the back plate 200 with at least two elastic locking pins 410, the anti-loosening capability when the back plate 200 is assembled to the frame 100 can be significantly improved, effectively reducing the probability of accidental detachment of the back plate 200 and further lowering the risk of the mobile terminal 300 accidentally dislodging from the protective case 010.

It should be understood that, in other embodiments, the locking pin 410 may also be elastically mounted on the back plate 200: when no external force acts on the locking pin 410, it remains in the locked position under elastic force and engages with the frame 100 to achieve connection between the back plate 200 and the frame 100; when the locking pin 410 is subjected to external force and moves to the unlocked position, it separates from the frame 100, thereby allowing the back plate 200 and the frame 100 to be separated from each other.

Meanwhile, in other embodiments, the number of locking pins 410 is not limited to two; it can also be three, four, etc., to match different structural strengths and operation methods.

As a preferred implementation, the locking pin mechanism 400 may further include a first elastic component 420, with the locking pin 410 elastically mounted on the frame 100 through the first elastic component 420. When the locking pin 410 moves toward the unlocked position under external force, the first elastic component 420 undergoes elastic deformation, such as being compressed or stretched; after the external force is removed, the locking pin 410 returns to the locked position under the elastic action of the first elastic component 420. Preferably, the first elastic component 420 is configured to keep the locking pin 410 always tending to move toward the locked position, further ensuring that the locking pin 410 can stably maintain locking and reliably engage with the back plate 200.

Here, the first elastic component 420 may include but is not limited to tension springs, torsion springs, compression springs, or elastic rubber blocks, etc.

It should be understood that in other embodiments, the locking pin 410 could also be made from an elastic material and formed into a structure capable of elastic resetting, thereby eliminating the need for an additional first elastic component 420.

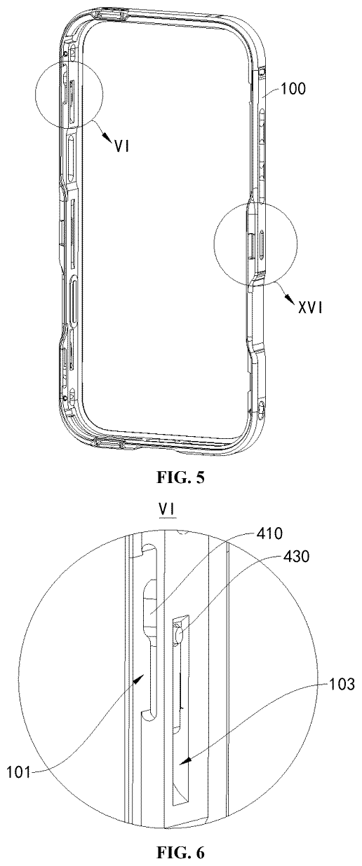

To make the switching of the locking pin 410 between the locked position and the unlocked position more stable and the guidance more reliable, please refer to FIGS. 5 and 6, the frame 100 is provided with a slide groove 101, and the locking pin 410 is slidably arranged within the slide groove 101.

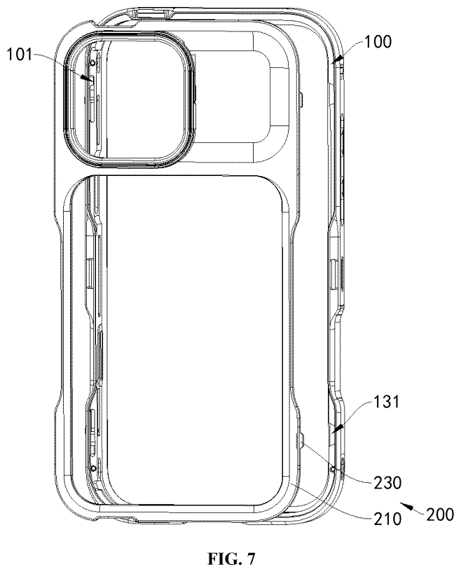

Preferably, please refer to FIGS. 6 and 7, the notch of the slide groove 101 is oriented toward the back plate 200, and the locking pin 410 can be assembled into the slide groove 101 through this notch. Since the back plate 200 is not yet connected to the frame 100 when assembling the locking pin 410, having the notch facing the back plate 200 side provides a more open assembly space, facilitating the assembly and maintenance of the locking pin 410.

Of course, in other embodiments, the notch of the slide groove 101 could also face toward the accommodating cavity.

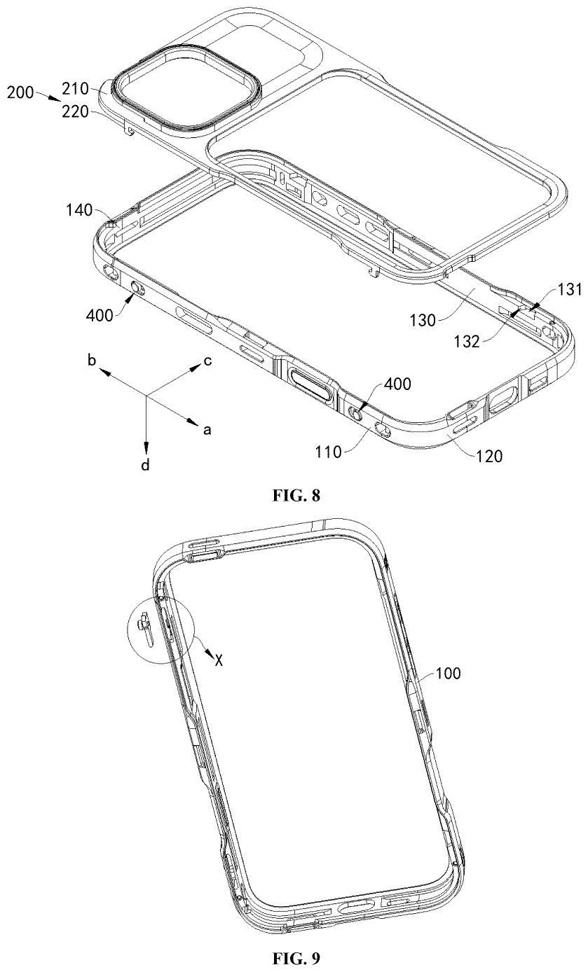

As a preferred implementation, please refer to FIGS. 7 and 8, the back plate 200 includes a back plate body 210 and a snap hook 220 connected to the back plate body 210. The snap hook 220 is detachably inserted into the slide groove 101 through the notch of the slide groove 101 and is used to form an engagement with the locking pin 410. The back plate body 210 provides back coverage and positioning for the mobile terminal 300 within the accommodating cavity, while in the assembled state, it covers the notch of the slide groove 101: on one hand, this reduces the likelihood of the locking pin 410 accidentally dislodging from the notch of the slide groove 101, thereby improving locking reliability; on the other hand, it enhances appearance consistency and overall aesthetics.

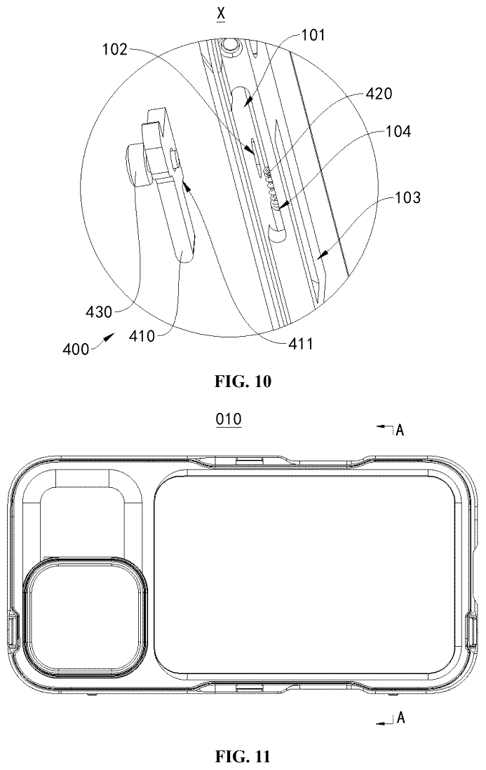

To ensure more stable and reliable installation of the first elastic component 420, as shown in FIGS. 9 and 10, a first stepped surface 104 is provided inside the slide groove 101, and a second stepped surface 411 is provided on the locking pin 410; the first elastic component 420 is placed inside the slide groove 101, with its two ends connected to the first stepped surface 104 and the second stepped surface 411 respectively, thereby stably positioning the first elastic component 420 between the frame 100 and the locking pin 410 to ensure the reliability of the locking pin 410 in the locked position.

Here, the connection methods between the first elastic component 420 and the first stepped surface 104 and the second stepped surface 411 may include but are not limited to abutting, snapping, etc.

Regarding the arrangement of the locking pins 410, as shown in FIG. 8, the frame 100 includes a first side edge 110, a second side edge 120, a third side edge 130, and a fourth side edge 140 connected end-to-end in sequence; both locking pins 410 are preferably elastically mounted on the first side edge 110. Placing both locking pins 410 on the same side edge facilitates simultaneous operation by the user to achieve unlocking, thereby enhancing connection stability while ensuring ease of back plate 200 removal.

Of course, in other embodiments, the two locking pins 410 may also be placed on different side edges, for example, one locking pin 410 on the first side edge 110 and the other on the second side edge 120 or the third side edge 130, etc.

As a preferred implementation, the first side edge 110 and the third side edge 130 have the same length, the second side edge 120 and the fourth side edge 140 have the same length, and the first side edge 110 is longer than the second side edge 120, meaning the first side edge 110 is the long side. Placing both locking pins 410 on the long side helps suppress any tendency for the back plate 200 to warp along the long side area, improving overall locking stability; on the other hand, it also provides more space for two-finger operation, thereby enhancing the convenience of removal.

To further improve the intuitiveness and convenience of unlocking, as shown in FIG. 8, one locking pin 410 is configured to be movable relative to the frame 100 along a first direction a to the unlocked position, while the other locking pin 410 is configured to be movable relative to the frame 100 along a second direction b to the unlocked position, with the first direction a opposite to the second direction b. This setup allows the user to simultaneously slide both locking pins 410 using a pinching gesture with two fingers, moving one locking pin 410 along the first direction a to the unlocked position and the other along the second direction b to the unlocked position, thereby increasing the ease of back plate 200 removal.

Preferably, when both locking pins 410 move toward the unlocked position, they are configured to move closer to each other for easier simultaneous operation; of course, they can also be configured to move apart to accommodate different ergonomic and structural layout requirements.

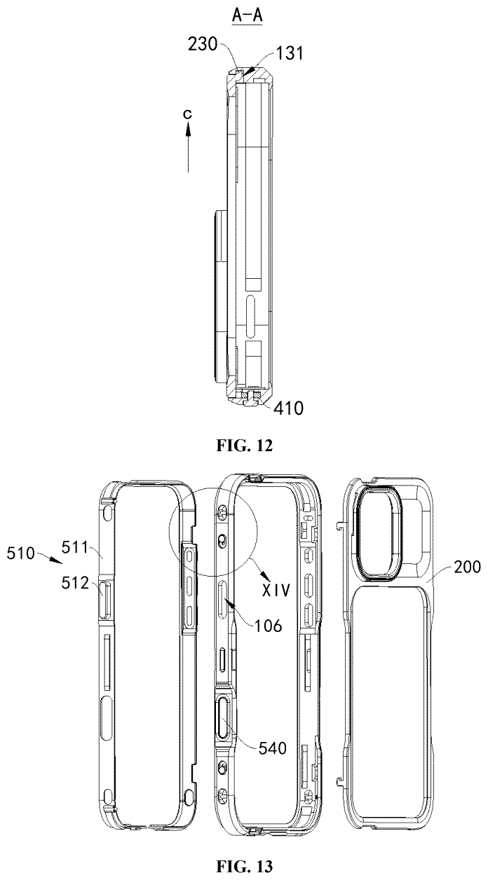

To make the assembly path of the back plate 200 clearer and the assembly smoother, please refer to FIGS. 8, 11, and 12. The back plate 200 has a relatively distributed first end and second end, where the first end is detachably snapped with the locking pin 410, and the second end is detachably inserted into the third side edge 130 of the frame 100. When connecting the back plate 200 to the frame 100, first the second end of the back plate 200 is inserted into the third side edge 130 for positioning, then the back plate body 210 is gradually fitted to the back of the mobile terminal 300, and finally the first end of the back plate 200 is snapped into and locked with the locking pin 410. During disassembly, first the locking pin 410 is separated from the back plate 200 to unlock the first end, then the second end of the back plate 200 is detached from the third side edge 130, thereby achieving a more user-friendly assembly and disassembly logic of “insert first then snap, unlock first then pull out.”

Furthermore, the second end of the back plate 200 is inserted into the third side edge 130 along a first set direction c, and the first end of the back plate 200 is snapped with the locking pin 410 along a second set direction d, with the first set direction c and the second set direction d distributed at an angle. By forming insertion positioning and snap locking in two different directions, the position of the back plate 200 can be constrained simultaneously along the first set direction c and the second set direction d, thereby further enhancing the overall stability when the back plate 200 is assembled onto the frame 100.

Optionally, please refer to FIGS. 7, 8, and 12. The back plate 200 also includes an insertion protrusion 230 connected to the back plate body 210. One end of the insertion protrusion 230 is connected to the back plate body 210, and the other end protrudes relative to the back plate body 210 along the first set direction c. The third side edge 130 of the frame 100 is provided with a slot 131, and the insertion protrusion 230 engages with the slot 131 along the first set direction c. Optionally, please refer to FIG. 8. The slot 131 has two relatively distributed slot walls 132, and the spacing between the two slot walls 132 gradually decreases along the insertion direction, meaning the two slot walls 132 are inclined relative to the first set direction c, to guide the insertion protrusion 230 using the slot walls 132 and improve stability upon insertion. In other embodiments, only one of the slot walls 132 may be inclined relative to the first set direction c to provide guidance.

Here, the connection methods between the insertion protrusion 230, the snap hook 220, and the back plate body 210 may include but are not limited to integral molding or adhesive bonding.

Optionally, the first set direction c is the width direction of the mobile terminal 300 assembled in the accommodating cavity, i.e., the direction from the first side edge 110 to the third side edge 130, and the second set direction d is the thickness direction of the mobile terminal 300 assembled in the accommodating cavity. The first set direction c and the second set direction d can be arranged perpendicularly; the first direction a and the second direction b are preferably both perpendicular to the first set direction c and the second set direction d, facilitating the unlocking action within the lateral space and making it independent of the insertion direction of the back plate, thereby reducing unintended interference.

To make driving the locking pin 410 to the unlocked position more effortless and intuitive, referring to FIGS. 4, 10, 13, and 14, the locking pin mechanism 400 further includes a toggle component 430. The frame 100 is provided with an elongated hole 102 communicating with the slide groove 101, located on the side of the frame 100 away from the accommodating cavity; the toggle component 430 is slidably inserted into the elongated hole 102 and connected to the locking pin 410, and under an external force, it can drive the locking pin 410 to overcome elastic action and slide to the unlocked position. Furthermore, the elongated hole 102 has a first end and a second end distributed along its length direction: when the toggle component 430 is at the first end, the locking pin 410 is at the locked position; when the toggle component 430 is at the second end, the locking pin 410 is at the unlocked position.

Here, the elongated hole 102 can be an oval hole, or of course, it can also be a rectangular elongated hole, etc.

In other optional embodiments (not shown), to reduce the risk of accidental unlocking of the back plate 200 caused by unintended pushing of the toggle component 430 during carrying or holding, and to make the unlocking action more aligned with user operation habits, the locking pin mechanism 400 can be configured with a “two-stroke unlocking” operational logic (not shown). Specifically, the travel of the toggle component 430 within the elongated hole 102 is divided into a first stroke and a second stroke: when the toggle component 430 moves within the first stroke, it drives the locking pin 410 only from the locked position to a “pre-unlocked position,” where although the locking pin 410 has disengaged from the primary locking cooperation with the snap hook 220, it still maintains a certain limiting/guiding relationship with the snap hook 220, preventing the back plate 200 from being directly detached from the frame 100 temporarily; when the toggle component 430 continues to move within the second stroke, the locking pin 410 further moves to the unlocked position and completely separates from the snap hook 220, at which point the back plate 200 can be detached from the frame 100. This setup enhances anti-misoperation capability while maintaining the convenience of a single toggle component 430 operation, and reduces operational discomfort caused by sudden popping up or instant release of the back plate 200.

In other optional embodiments (not shown), to keep the toggle component 430 more stable in the locked position and prevent minor displacement of the toggle component 430 within the elongated hole 102 due to vibration or friction, which could reduce the locking force, a self-retaining positioning structure (not shown) may be provided between the toggle component 430 and the elongated hole 102. For example, when the toggle component 430 is at the locking end of the elongated hole 102, it forms a locking engagement with the elongated hole 102, making it difficult for the toggle component 430 to leave the locking end without external force; when unlocking is required, the operator can first apply a pressing or lateral unlocking action to the toggle component 430 to release the locking engagement, then push the toggle component 430 along the direction of the elongated hole 102 to complete the unlocking stroke. Optionally, a temporary retention engagement may also be set when the toggle component 430 is at the unlocked end position, so that the operator does not need to continuously apply force to keep the toggle component 430 at the unlocked end during the removal of the back plate 200, thereby further improving disassembly convenience and operational reliability (not shown).

Furthermore, referring to FIGS. 6 and 10, the frame 100 is also provided with a relief groove 103 connected to the slide groove 101, with the notch of the relief groove 103 facing the accommodating cavity; one end of the toggle component 430 is exposed from the elongated hole 102, and the other end is exposed from the relief groove 103. This arrangement, on one hand, allows the toggle component 430 and the locking pin 410 to form a more stable through-type connection, enhancing the stability when the toggle component 430 drives the locking pin 410 to move; on the other hand, the relief groove 103 prevents the slot wall of the slide groove 101 from interfering with the movement of the toggle component 430, thereby ensuring smooth and reliable unlocking action.

To improve the positioning stability of the mobile terminal 300 within the accommodating cavity and enhance cushioning protection, referring to FIG. 13, the mobile terminal protective case 010 further includes a rubber pad 510. The rubber pad 510 is arranged on the inner side wall of the frame 100, i.e., the side wall of the frame 100 facing the accommodating cavity. When the mobile terminal 300 is embedded into the frame 100, the rubber pad 510 abuts against the mobile terminal 300 to reduce shaking and provide cushioning.

The rubber pad 510 can be fixed to the frame 100 by means such as adhesion or snap-fit.

Optionally, the rubber pad 510 includes a rubber pad body 511 and a projection 512 connected to the rubber pad body 511, with the frame 100 provided with a first through hole 105; the rubber pad body 511 is connected to the side wall of the frame 100 facing the accommodating cavity, the projection 512 is embedded in the first through hole 105 and exposed from it, and the projection 512 is aligned with a button on the mobile terminal 300, such as a volume key, to facilitate pressing the projection 512 to trigger the button of the mobile terminal 300.

The aforementioned “exposed” can mean that the projection 512 protrudes outward relative to the first through hole 105, is flush with the first through hole 105, or is recessed relative to the first through hole 105 but is still not blocked by the edge of the through hole.

To further facilitate the removal of the back plate 200, please refer to FIG. 15. The mobile terminal protective case 010 also includes a second elastic component 520. The second elastic component 520 is arranged on the back plate 200 and located within the accommodating cavity; when the back plate 200 is assembled to the frame 100 and the mobile terminal 300 is placed in the accommodating cavity, the mobile terminal 300 presses against the second elastic component 520, causing it to deform under compression. When both locking pins 410 move to the unlocked position, thereby releasing the first end of the back plate 200, the second elastic component 520 returns to its original state due to its own elasticity, providing a slight lifting force to the back plate 200. This creates a tendency for the first end of the back plate 200 to separate from the frame 100, making it easier for the user to further separate the second end of the back plate 200 from the third side edge 130, resulting in a smoother removal operation.

Here, the second elastic component 520 may include, but is not limited to, a rubber pad, a spring, etc.; its connection method to the back plate 200 may include, but is not limited to, adhesion, snap-fit, etc.

In other optional embodiments, to enhance dust resistance, sweat resistance, or splash resistance, a sealing structure (not shown) may be provided at the junction between the frame 100 and the back plate 200. Specifically, the frame 100 and the back plate 200 may form a continuous sealing surface at the circumferential contact position, with an elastic sealing strip or sealing ring installed on the sealing surface, so that when the back plate 200 is assembled, the sealing strip is compressed to form a continuous circumferential seal. Alternatively, a flexible overmolded area may be provided along the periphery of the back plate 200, which presses against the frame 100 to form a seal. This setup reduces the likelihood of gaps in the split structure becoming channels for dust or liquid intrusion, improving the environmental adaptability of the protective case 010 in outdoor, sports, and other scenarios.

In other optional embodiments, to simplify the assembly of the rubber pad 510 and ensure more uniform support for the mobile terminal 300 within the accommodating cavity, the rubber pad 510 may be designed as an integrated liner structure (not shown). Specifically, the rubber pad body 511 may extend continuously along the inner side wall of the frame 100 to form a ring-shaped or segmented elastic liner, with projections 512 correspondingly formed at positions requiring button activation to cooperate with the first through hole 105, while the remaining areas provide continuous support and cushioning for the mobile terminal 300. This design helps mitigate issues such as insufficient local support or inconsistent thickness caused by assembly errors of scattered rubber pads and reduces the likelihood of the mobile terminal 300 shaking within the accommodating cavity.

In other optional embodiments, to achieve a smooth lifting effect even when the back plate 200 has a large size, multiple locking points, or high mating resistance, the second elastic component 520 may be arranged in a multi-point layout (not shown). Specifically, multiple second elastic components 520 can be placed in the area of the back plate 200 near the first end, allowing the first end of the back plate 200 to be acted upon by multiple lifting points after unlocking, thereby generating a more uniform lifting tendency; alternatively, the second elastic component 520 can be arranged in a combination of the central and corner areas of the back plate 200 to mitigate issues such as skewing or jamming of the back plate 200 caused by single-point lifting. This configuration enhances the automatic separation effect of the back plate 200 after unlocking and further improves the ease of disassembling the back plate 200.

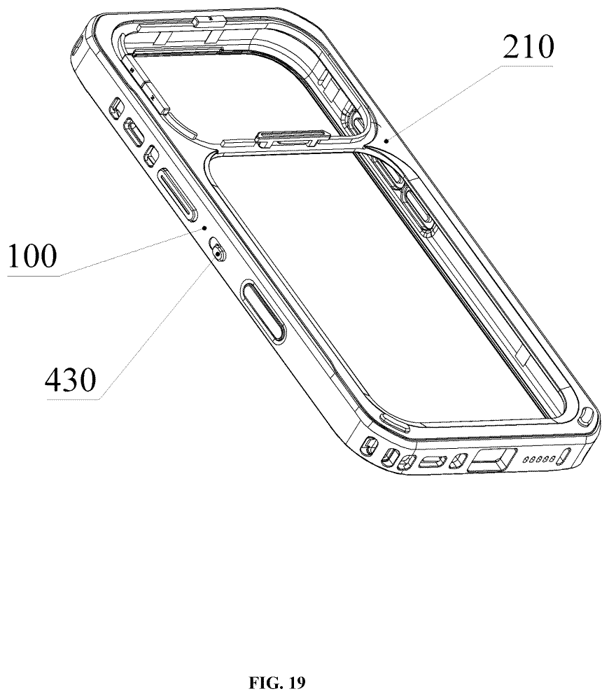

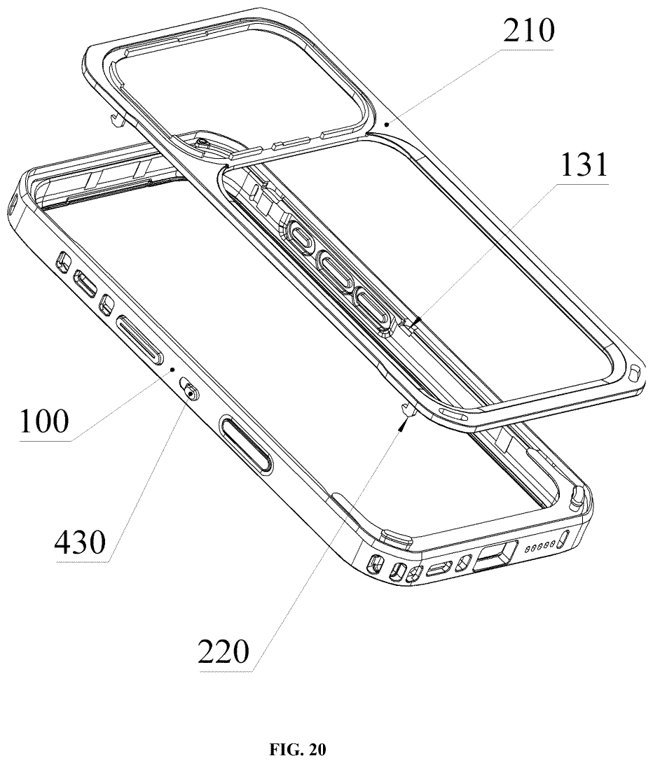

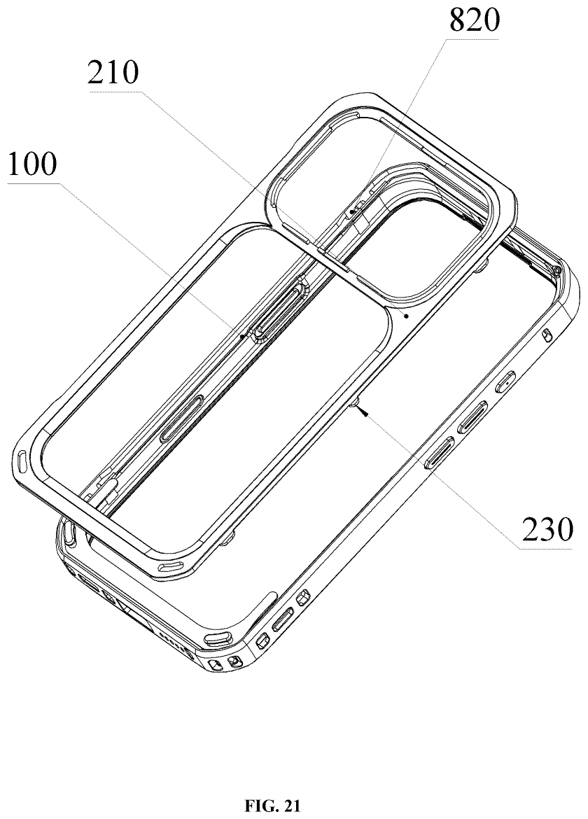

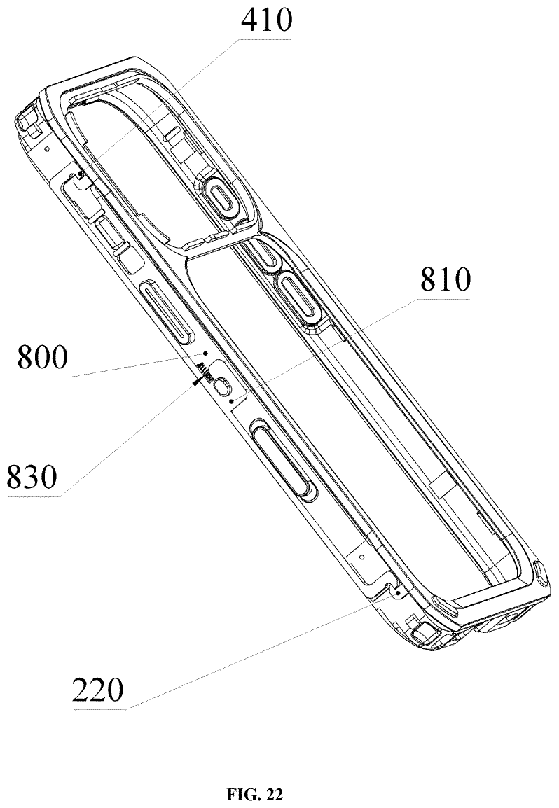

To improve the assembly efficiency and synchronization reliability of the dual locking pin 410 structure, in cases where two locking pins 410 are installed on the mobile terminal protective case 010, this embodiment introduces a simultaneous control scheme. Please refer to FIGS. 19 to 22, where a single toggle component 430 is used to drive both locking pins 410 in unison. Specifically, a sliding cavity 800 is formed inside the frame 100 on the side away from the slot 131, and a sliding plate 810 is slidably arranged along the length direction within the sliding cavity 800. The sliding plate 810 has an overall “ [symbol] ”-shaped structure (a profile including three upwardly projecting peaks), with locking pins 410 integrally or fixedly mounted at the top of both ends, and the protruding ends of the two locking pins 410 face the same side to ensure consistent locking directions. Correspondingly, clamping grooves 820 are opened at the top of the sliding cavity 800, centered symmetrically around the central point of the sliding plate 810's “ [symbol] ” shape. The clamping groove 820 provides an entry channel and clearance space for the snap hook 220 on the back plate body 210 during assembly. A toggle component 430 is installed at the central point of the sliding plate 810's “ [symbol] ” shape, preferably partially exposed outside the frame 100 for ease of operation, and may feature anti-slip patterns or bumps to enhance tactile feedback. Meanwhile, one end of the toggle component 430 is connected to a third elastic component 830, and the other end of the third elastic component 830 abuts against the inner wall of the sliding cavity 800, thereby providing resetting elastic force to the sliding plate 810 and keeping it in the default locked position when not in operation.

When installing the back plate body 210, first insert the insertion protrusion 230 at one end of the back plate body 210 into the slot 131 on the frame 100 to achieve positioning on one side. Then, align the two snap hooks 220 at the other end of the back plate body 210 above the clamping groove 820, and press the back plate body 210 so that the snap hooks 220 enter the interior of the sliding cavity 800 through the clamping groove 820. To achieve “self-guiding” locking, the top surfaces of both snap hooks 220 and the corresponding locking pins 410 are designed as mutually matching inclined guiding surfaces, with both snap hooks 220 oriented in the same direction; thus, during the pressing process, the inclined surfaces of the snap hooks 220 and the locking pins 410 form a wedge-shaped guiding relationship. Under vertical pressing force, the snap hooks 220 push the sliding plate 810 along the sliding cavity 800, causing the two locking pins 410 to simultaneously yield, allowing the snap hooks 220 to smoothly pass over the locking pins 410 and complete entry. Once the snap hooks 220 fully enter the predetermined locking position, the third elastic component 830 drives the sliding plate 810 to reset in the opposite direction, causing the two locking pins 410 to simultaneously rebound and form a limiting lock with the snap hooks 220, thereby achieving two-point locking of the back plate body 210. This structure uses a single sliding plate 810 to achieve synchronized locking at two points, which can reduce assembly steps, minimize error accumulation, and enhance the consistency and reliability of simultaneous engagement of the dual locking pins.

When the back plate body 210 needs to be removed, the operator slides the toggle component 430 in the predetermined direction. The toggle component 430 drives the sliding plate 810 to displace against the elastic force of the third elastic component 830, causing the two locking pins 410 to simultaneously retract (releasing the limit on the snap hooks 220). After the locking pins 410 exit the locking area of the snap hooks 220, the back plate body 210 can be lifted from the pressing end and separated from the frame 100. Finally, withdraw the insertion protrusion 230 from the slot 131 to complete disassembly. To prevent accidental detachment due to mishandling, in other embodiments (not shown), the toggle component 430 can be further equipped with a rebound self-resetting structure, an operation damping structure, or a secondary limiting structure (such as requiring pressing before sliding or setting a minimum travel threshold), thereby balancing convenience and safety.

In other optional embodiments, to ensure that the locking pin mechanism 400 maintains good installation and removal convenience even when multiple locking pins 410 are provided (e.g., four locking pins 410, which can also be extended to six or more), the mobile terminal protective case 010 can be configured as follows: the operator only needs to operate one toggle component 430 to synchronously drive multiple locking pins 410 into the unlocked state, thereby allowing the back plate 200 to be quickly detached from the frame 100. This embodiment still follows the basic principle that “the locking pin 410 is defaulted to the locked position under the elastic action of the first elastic component 420 and switches to the unlocked position under external force.” The difference lies in synchronizing the unlocking actions of multiple locking pins 410 through an internal linkage structure, simplifying the operation from “unlocking one by one” to “single toggle, one-time unlocking,” thereby improving efficiency and reducing the risk of misoperation.

Specifically, four locking pins 410 are arranged on the frame 100. These four locking pins 410 are slidably installed in corresponding slide grooves 101, respectively, and are elastically biased to the locked position by the first elastic component 420. The back plate 200 includes a back plate body 210 and snap hooks 220, with the snap hooks 220 arranged in one-to-one correspondence with the four locking pins 410. When all four locking pins 410 are in the locked position, they engage with the corresponding snap hooks 220 respectively, forming a four-point lock to securely fix the back plate 200 onto the frame 100. Preferably, the notch of the slide groove 101 faces the back plate 200, and the back plate body 210 covers the notch of the slide groove 101 in the assembled state, thereby reducing the risk of accidental dislodgement of the locking pin 410 from the notch and enhancing the integrated appearance as well as dust and dirt resistance.

To achieve “single toggle component 430 for synchronous unlocking,” an elongated hole 102 can be opened on the side of the frame 100 opposite the accommodating cavity. The toggle component 430 is slidably inserted into the elongated hole 102 and connected to the linkage structure within the locking pin mechanism 400. This linkage structure is used to synchronously transmit the single sliding displacement of the toggle component 430 to the four locking pins 410, causing all four locking pins 410 to simultaneously overcome the elastic action of their respective first elastic components 420 and move toward the unlocked position when the toggle component 430 is pushed. To improve transmission stability and tolerance adaptability, sliding fits or connections allowing slight floating can be adopted between the toggle component 430 and the linkage structure, as well as between the linkage structure and each locking pin 410, to avoid jamming due to machining tolerances, assembly deviations, or slight deformation of the frame 100, and to ensure consistent unlocking travel for each locking pin 410.

In the locked state, the toggle component 430 is positioned at the locked end of the elongated hole 102, and the four locking pins 410 are each held in the locked position by the first elastic component 420, engaging with the snap hooks 220, thereby securely fixing the back plate 200 to the frame 100. When disassembly of the back plate 200 is required, personnel only need to slide the toggle component 430 along the elongated hole 102 to the unlocked end position. The toggle component 430, through the linkage structure, simultaneously drives all four locking pins 410 to move toward the unlocked position, causing the four locking pins 410 to disengage from the corresponding snap hooks 220 at the same time. This releases the four-point lock at once, allowing the back plate 200 to be separated from the frame 100. After personnel release the toggle component 430, the four locking pins 410 can automatically reset to the locked position under the elastic force of their respective first elastic components 420, and can reversely drive the linkage structure and the toggle component 430 back to their initial positions. If necessary, travel stops, positioning dimples/projections, or damping structures can be provided at both ends of the elongated hole 102, giving the toggle component 430 a clear stop and positioning feel at the locked and unlocked ends, further enhancing protection against accidental contact and operational reliability.

Furthermore, to accommodate different spatial layouts and transmission requirements, the linkage structure can be implemented in various equivalent forms. For example, a pulling member arranged circumferentially along the frame 100 can be used in conjunction with steering guides to convert the linear sliding of the toggle component 430 into synchronized pulling in multiple directions. Alternatively, a linkage/push-rod mechanism arranged along the frame 100 can be employed to distribute the displacement of the toggle component 430 and output it to the driving ends of the four locking pins 410, achieving simultaneous retraction. Through such synchronized linkage methods, issues like “asynchronous unlocking, where one side of the back plate 200 loosens first while the other side remains locked” when the number of locking pins increases can be effectively avoided, reducing disassembly resistance and minimizing the risk of wear or damage to the locking pins 410 or snap hooks 220 due to uneven loading.

In a specific optional embodiment, the linkage structure may adopt a rigid connecting rod type distribution mechanism. Specifically, a movable connecting rod assembly is arranged inside the frame 100 along the circumferential direction, and the toggle component 430 is connected to one of the main connecting rods; the main connecting rod undergoes linear displacement when pushed by the toggle component 430, and both ends of the main connecting rod are transmission-connected to branch connecting rods in other directions through steering connecting rods (or swing arm structures) at the corners of the frame, thereby distributing the displacement of the main connecting rod to different directions. The ends of each branch connecting rod are respectively slidably or hingedly engaged with the driving end of the corresponding locking pin 410, so that when the toggle component 430 slides, all four locking pins 410 simultaneously overcome the elastic action of the first elastic component 420 and retract toward the unlocked position; after the external force is removed, the four locking pins 410 reset under the action of the first elastic component 420 and drive the entire connecting rod assembly back to its original position. To enhance tolerance adaptability, a connection method allowing slight floating (such as elongated hole matching with a pin shaft, slide groove matching with a slider, etc.) is preferably used between the connecting rods and the locking pin 410 to reduce the probability of jamming caused by assembly errors.

In another specific optional embodiment, the linkage structure may adopt a flexible traction type linkage structure to accommodate narrow internal space or restricted corner layout within the frame 100. Specifically, the toggle component 430 is connected to one end of a flexible traction component (such as a flexible cable or strip-shaped traction component), the traction component is routed along the circumference of the frame 100, and its direction is changed through guide components at the corners of the frame; the traction component is connected to the driving end of the corresponding locking pin 410 near each locking pin 410. In the locked state, the locking pin 410 is in the locked position under the action of the first elastic component 420, and the traction component is in a slack or pre-tensioned state; when the toggle component 430 slides along the elongated hole 102, the traction component is pulled and simultaneously pulls all four locking pins 410 toward the unlocked position, achieving four-point synchronous unlocking; after the toggle component 430 is released, the locking pin 410 resets under the action of the first elastic component 420 and drives the traction component back in the reverse direction, thereby returning the toggle component 430 to its initial position. To improve synchronization and consistency, a tension adjustment structure can be set on the traction component to compensate for length differences caused by manufacturing errors, making the unlocking stroke of each locking pin 410 more consistent.

In another optional embodiment, to further reduce the operating force of the toggle component 430 and minimize the potential transient peak resistance when the four locking pins 410 retract simultaneously, a two-stage stroke linkage structural approach may be adopted. Specifically, the toggle component 430 still slides within the elongated hole 102, but its stroke is divided into a first stroke and a second stroke: during the first stroke, the toggle component 430 drives two of the locking pins 410 into a semi-unlocked position through the linkage structure (i.e., disengaged from the main locking surface of the snap hook 220 while still maintaining guided retention); during the second stroke, the toggle component 430 continues sliding and triggers the second-stroke output of the linkage structure, causing the remaining two locking pins 410 to enter the unlocked position, while further moving the initial two locking pins 410 into a fully unlocked position. By releasing the locking in stages, peak force can be reduced, operational feel improved, and the risk of sudden jerking of the back plate 200 during instant disengagement minimized.

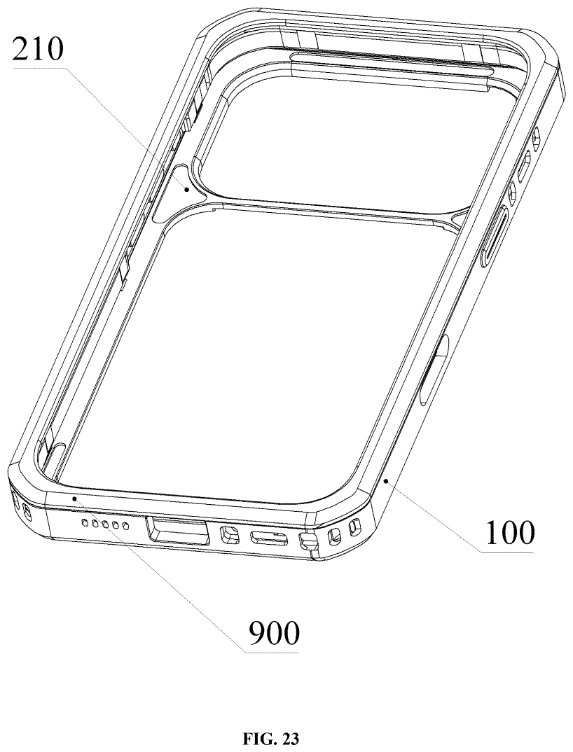

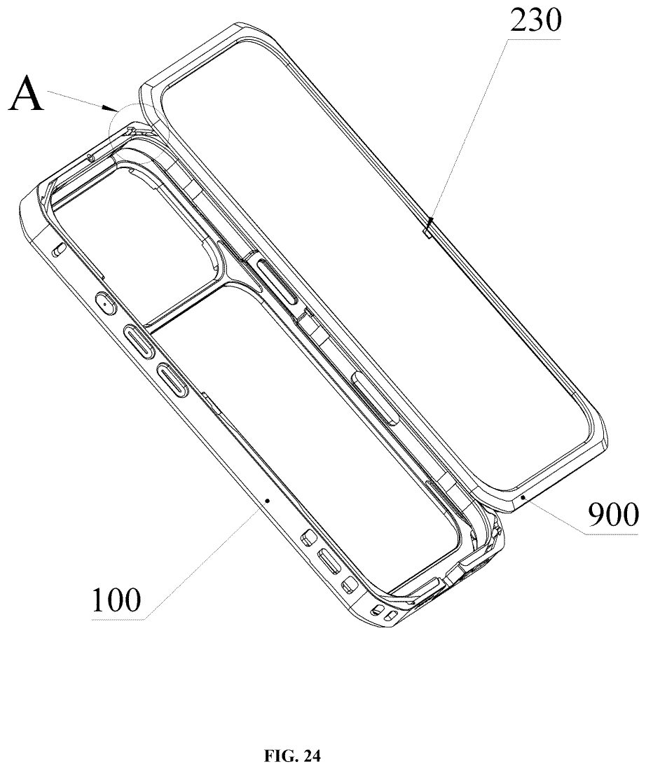

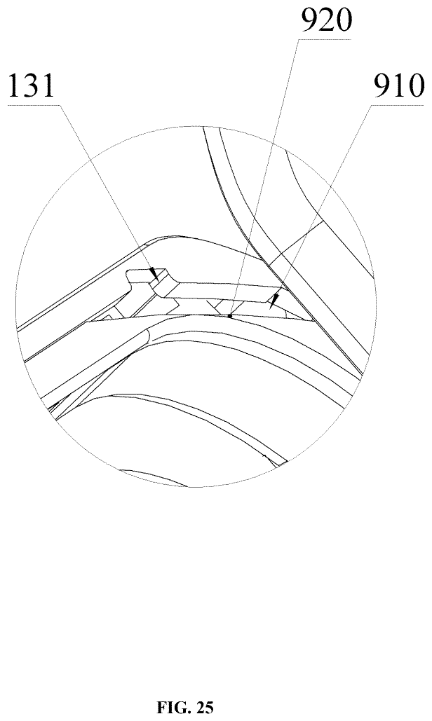

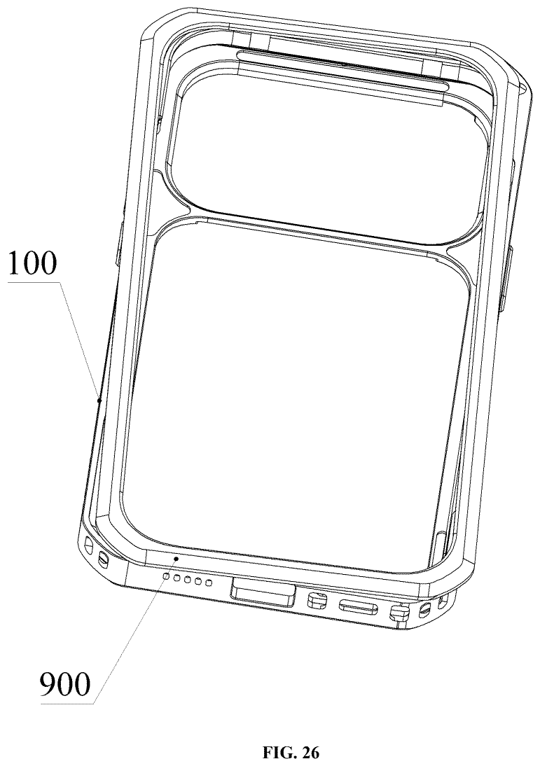

To adapt to different usage scenarios and enhance overall structural strength and assembly consistency, in this embodiment, referring to FIGS. 23 to 26, the back plate body 210 may be integrally formed with the frame 100, thereby creating a one-piece frame structure. The front cover 900 is detachably mounted on the side surface of the frame 100 away from the back plate body 210. The front cover 900 is preferably configured as a square shaped frame structure, meaning it forms a ring-shaped frame only along the peripheral edges of the mobile terminal's front side, with a central open area, primarily providing positioning and protection for the four sides of the mobile terminal without obstructing the screen display area. It serves to offer circumferential positioning, edge protection, and slight compressive retention for the peripheral edges of the mobile terminal in the assembled state, reducing the risk of shaking and dislodgment within the protective case 010.

Specifically, the front side of the frame 100 is provided with several slots 131, exemplified as six in this embodiment (in other embodiments, the number of slots 131 may be no less than six). Preferably, the slots 131 are arranged at the four corners of the frame 100 and on both sides near the central area of the frame, to form multi-point constraints and evenly distribute assembly forces. Each slot 131 may be located on an inclined surface of the front side of the frame 100 to enhance smoothness during guided assembly; moreover, one end of each slot 131 extends to form an insertion slot 910 (which can be understood as a locking segment), used to position and limit the insertion projection 230 after the front cover 900 is rotated into place. The front side of the frame 100 may also include slide rails 920, which cooperate with the slots 131 to define the relative sliding path of the front cover 900 during assembly, ensuring that the insertion projection 230 enters the insertion slot 910 along a predetermined trajectory, avoiding skewing or jamming and improving assembly consistency.

When installing the front cover 900, the user tilts the rectangular front cover 900 at a predetermined angle close to the frame 100, aligning each insertion protrusion 230 to first enter the entry segment of the corresponding slot 131. Then, the user rotates the front cover 900, causing the insertion protrusion 230 to slide relatively under the guidance of the slot 131 and the slide rail 920, and further slide into the insertion slot 910, thereby achieving a fixed connection between the front cover 900 and the frame 100. After assembly, the inner edge of the front cover 900 provides slight compression or shoulder retention on all four sides of the mobile terminal, stabilizing its circumferential position within the protective case 010 and offering impact protection at the edges.

When removing the front cover 900, the user only needs to rotate the front cover 900 in the opposite direction of installation, causing the insertion protrusion 230 to exit the insertion slot 910 and return to the entry segment of the slot 131, then lift or pull the front cover 900 away at an angle to detach the insertion protrusion 230 from the slot 131, completing the removal. To enhance reliability, in other embodiments (not shown), friction preload or elastic retention structures can be added between the insertion slot 910 and the insertion protrusion 230 to reduce loosening and noise during use; if necessary, travel stops can also be set at both ends of the slide rail 920, giving the front cover 900 clear stops and tactile feedback at the locked and unlocked positions, thereby reducing the risk of accidental detachment due to unintended contact.

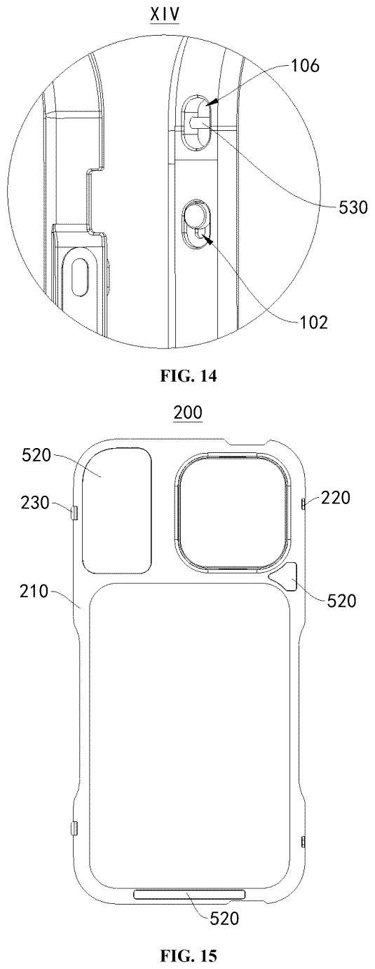

To improve convenience, refer to FIG. 14, the mobile terminal protective case 010 may also include a lanyard pin 530, which is connected to the frame 100 for attaching a lanyard. Optionally, the frame 100 has a second through hole 106, with the lanyard pin 530 located inside it to minimize protrusion and enhance grip comfort. The connection between the lanyard pin 530 and the frame 100 can include but is not limited to interference fit, threaded connection, etc. The number and arrangement of lanyard pins 530 can be set as needed; for example, in this embodiment, three lanyard pins 530 can be installed, with two at each end along the length of the first side edge 110 and one at one end along the length of the third side edge 130; of course, one, two, four, etc., can also be used.

Additionally, refer to FIG. 13, the mobile terminal protective case 010 may also include a touch module 540, which is installed on the frame 100 and can be a capacitive module to ensure normal operation of the side touch keys of the mobile terminal 300. The touch module 540 can be mounted on the frame 100 through snap-fit, adhesive bonding, etc., and can be placed on any of the first side edge 110, second side edge 120, third side edge 130, or fourth side edge 140.

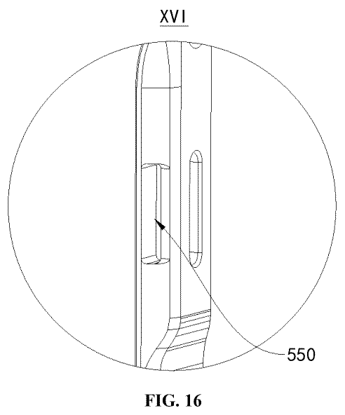

Furthermore, referring to FIG. 16, the frame 100 may also be provided with a positioning groove 550, which is used for assembling extension components to achieve functional expansion.

Optionally, the positioning groove 550 includes two notches facing different directions to facilitate the assembly of different extension components from various orientations; for example, one notch is oriented toward the back plate body 210, while the other notch faces away from the accommodating cavity. The number of positioning grooves 550 can also be set as needed; for instance, in this embodiment, one positioning groove 550 is provided on each of the four side edges, though it is also possible to set one, two, three, six, etc. Additionally, the frame 100 may include a MIC hole and a USB connection port, such as a Type-C port, according to the interface positions of the mobile terminal 300, which can be located on any of the four side edges.

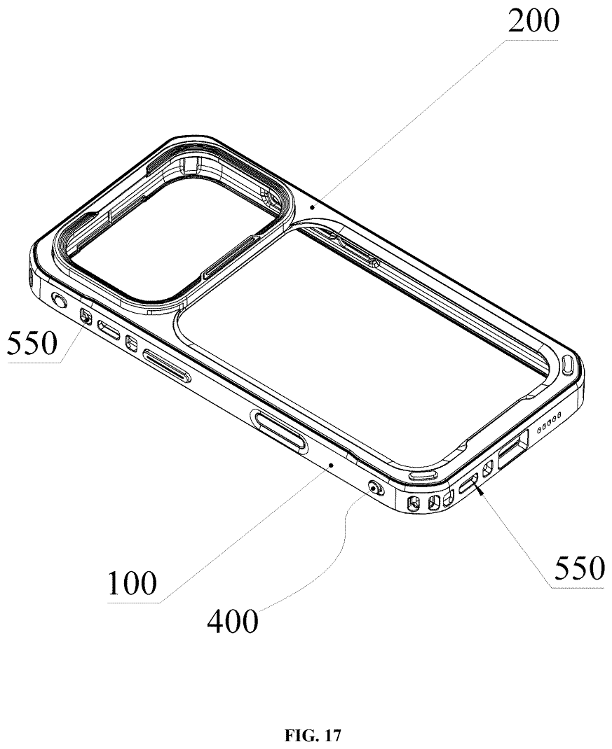

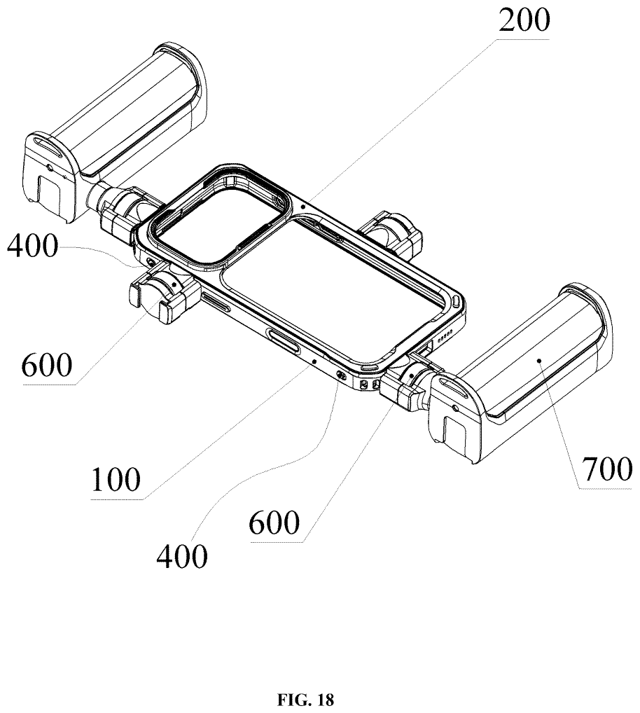

In other optional embodiments, referring to FIGS. 17 and 18, the mobile terminal protective case 010 may further include a quick-release component 600. The quick-release component 600 is detachably mounted on the positioning groove 550 of the frame 100, and the end of the quick-release component 600 away from the positioning groove 550 is used for fixedly installing expansion modules, such as a stand module, a clip-on module, a magnetic module, a fill-light module, an external power module, or other functional modules.

By providing the quick-release component 600 on the protective case 010, the positioning groove 550 serves to offer rapid positioning and reliable locking for the quick-release component 600; when installing an expansion module, the user only needs to align the quick-release component 600 with the positioning groove 550 and complete the insertion/locking to quickly assemble the expansion module onto the mobile terminal protective case 010; when removing the expansion module, the user can release the locking relationship between the quick-release component 600 and the positioning groove 550 to swiftly detach the expansion module from the protective case 010. This configuration enables quick installation and removal of expansion modules without compromising the basic protective function of the protective case 010, thereby enhancing the flexibility and convenience of configuring and using expansion features.

To further improve the user's grip experience and convenience of use, referring to FIGS. 17 and 18, the expansion module may include a handle 700. The handle 700 is detachably mounted on the end of the quick-release component 600 away from the positioning groove 550, forming an integrated grip structure with the mobile terminal protective case 010. By incorporating the handle 700, users can hold the protective case 010 equipped with the mobile terminal 300 more securely and comfortably, making it easier for video viewing, photography, or extended use, while reducing the risk of accidental drops.

In other optional embodiments (not shown), to enhance the wear resistance and structural strength of the positioning groove 550 during frequent installation and removal of expansion components, the frame 100 may be provided with a reinforcement structure in the area of the positioning groove 550. For example, local thickening or rib reinforcement structures can be arranged around the positioning groove 550 to improve its resistance to deformation; or a wear-resistant enhancement layer can be applied to the load-bearing edges of the positioning groove 550, ensuring that the geometric shape and assembly clearance of the positioning groove 550 remain more stable during repeated insertion and removal of the quick-release component 600. This configuration helps reduce the risk of wear and loosening of the positioning groove 550 after long-term use, ensuring the stability and service life of the expansion components after assembly.

In other optional embodiments, to meet the operational needs of interactive scenarios such as gaming, the handle 700 can also integrate a wireless communication module, such as a Bluetooth communication module, to establish a wireless connection with the mobile terminal 300; meanwhile, multiple operation buttons, such as directional keys, function keys, and trigger keys, can be provided on the handle 700. These buttons are used to send control commands to the mobile terminal 300, enabling game operations or other application controls on the mobile terminal 300. This setup allows for the addition of grip and control functions without altering the basic protective function of the mobile terminal protective case 010, enhancing overall convenience and functionality. In other optional embodiments (not shown), to improve the stability of the handle 700 during video viewing or gaming control and reduce off-center loading at the quick-release component 600 and positioning groove 550, the handle 700 can be equipped with anti-rotation limiting and conforming load-bearing structures (not shown). Specifically, the connection end of the handle 700 with the quick-release component 600 can include anti-rotation limiting features, preventing the handle 700 from swinging relative to the frame 100 after assembly; simultaneously, the handle 700 can have a conforming surface that matches the shape of the frame 100, allowing forces during gripping to be distributed and transmitted to multiple areas of the frame 100, rather than concentrated solely at the single connection point of the quick-release component 600 and positioning groove 550. This configuration enhances the consistency of feel during prolonged gripping and gaming operations and improves the structural stability of the expansion module after assembly.

In other embodiments (not shown), the quick-release component 600 may include a mounting base, a clamping mechanism, and a trigger mechanism linked to the clamping mechanism. Here, the mounting base is configured to cooperate with the positioning groove 550; the clamping mechanism is configured to clamp or latch onto the positioning groove in a locked state, thereby retaining the quick-release component 600 on the positioning groove 550; the trigger mechanism can, upon user operation, drive the clamping mechanism to perform clamping or releasing actions in at least one direction, enabling rapid assembly or disassembly between the quick-release component 600 and the positioning groove 550.

In some embodiments, the trigger mechanism can be configured to have a first stroke and a second stroke: the first stroke is used to achieve the clamping or loosening of the clamping mechanism, and the second stroke is used to create a pre-compression tendency between the clamping mechanism and the positioning groove 550, to reduce assembly gaps and improve the stability of the expansion module after installation, such as reducing wobbling. The structural form of the aforementioned trigger mechanism is not limited to a knob-type structure; it can also be a lever-type, slider-type, or press-type, etc., as long as it can achieve locking/unlocking control of the clamping mechanism.

The assembly process of this embodiment may include: embedding the mobile terminal 300 into the frame 100 from the back of the frame 100; inserting the second end of the back plate 200 into the third side edge 130 of the frame 100; gradually fitting the back plate body 210 to the back of the mobile terminal 300; and engaging and locking the first end of the back plate 200 with the locking pin 410 at the first side edge 110 of the frame 100.

The disassembly process of this embodiment may include: pushing the toggle component 430 or directly pushing the locking pin 410 to move the locking pin 410 to the unlocked position; causing the first end of the back plate 200 to tend to lift and separate under the action of the second elastic component 520, if present; separating the second end of the back plate 200 from the third side edge 130; and finally pushing the mobile terminal 300 out of the frame 100 from the front of the frame 100.

In summary, the mobile terminal protective case 010 of this application reliably locks the back plate 200 through at least two elastic locking pins 410, and cooperates with the positioning structure at the insertion end, the unlocking structure of the toggle component 430, and the auxiliary lifting structure of the second elastic component 520. This improves the connection stability between the back plate 200 and the frame 100 while also considering the convenience of assembly and disassembly, thereby effectively reducing the risk of accidental detachment of the back plate 200 and accidental ejection of the mobile terminal 300.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on...”, “above...”, “on the upper surface of...”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A mobile terminal protective case, comprising:
a frame;
a back plate detachably arranged on the frame to form an accommodating cavity for housing a mobile terminal; and
a locking pin mechanism, comprising at least two locking pins elastically arranged on at least one of the frame and the back plate, and the locking pins have a locked position and an unlocked position;
wherein when no external force is applied to the locking pins, the locking pins are capable of moving to the locked position under an elastic action and being engaged with the other of the frame and the back plate; and
when an external force is applied to the locking pins to overcome the elastic action and move the locking pins to the unlocked position, the locking pins are separated from the other of the frame and the back plate.

2. The mobile terminal protective case according to claim 1, wherein the locking pin mechanism further comprises a first elastic component, and the locking pins are elastically arranged on the other of the frame and the back plate through the first elastic component.

3. The mobile terminal protective case according to claim 1, wherein one of the frame and the back plate is provided with a slide groove, and the locking pins are slidably arranged within the slide groove.

4. The mobile terminal protective case according to claim 3, wherein the frame is provided with the slide groove, and a notch of the slide groove is oriented toward the back plate, and the locking pins are configured to be assembled into the slide groove from the notch of the slide groove.

5. The mobile terminal protective case according to claim 4, wherein the back plate comprises a back plate body and a snap hook connected to the back plate body, and the snap hook is detachably inserted into the slide groove from the notch of the slide groove.

6. The mobile terminal protective case according to claim 3, wherein the locking pin mechanism further comprises a toggle component, and one of the frame and the back plate is provided with an elongated hole communicating with the slide groove; the toggle component is slidably inserted into the elongated hole and connected to the locking pins; and
the toggle component is capable of, under an external force, driving the locking pins to overcome the elastic action and slide toward the unlocked position.

7. The mobile terminal protective case according to claim 6, wherein one of the frame and the back plate is further provided with a relief groove communicating with the slide groove, and a notch of the relief groove is oriented toward the accommodating cavity; one end of the toggle component is exposed from the elongated hole, and the other end is exposed from the relief groove.

8. The mobile terminal protective case according to claim 1, wherein the frame comprises a first side edge, a second side edge, a third side edge and a fourth side edge connected end-to-end in sequence, and at least two locking pins are elastically arranged on the first side edge.

9. The mobile terminal protective case according to claim 8, wherein one of the locking pins is configured to be movable relative to the frame along a first direction to the unlocked position; the other locking pin is configured to be movable relative to the frame along a second direction to the unlocked position, wherein the first direction is opposite to the second direction.

10. The mobile terminal protective case according to claim 8, wherein the back plate has a first end and a second end distributed oppositely, the second end of the back plate is inserted into the third side edge along a first set direction, and the first end of the back plate is engaged with the locking pin along a second set direction, wherein the first set direction and the second set direction are distributed at an angle; and
the first side edge and the third side edge have a same length, the second side edge and the fourth side edge have a same length, wherein the length of the first side edge is greater than that of the second side edge.

11. A mobile terminal protective case, comprising:
a frame;
a back plate detachably connected to the frame to cooperate with the frame to define an accommodating cavity for accommodating a mobile terminal; and
a pair of locking assemblies arranged on the frame;
wherein each locking assembly comprises:
a slide groove provided on the frame, the slide groove having an open notch facing the back plate;
locking pin components slidably accommodated within the slide groove and movable between a locked position and an unlocked position;
a spring arranged within the slide groove, elastically biasing the locking pin components to the locked position; and
a toggle component coupled to the locking pin components and operable from outside the frame through an elongated hole formed on an outer side of the frame;
wherein the back plate comprises a snap hook insertable into the slide groove through the open notch;
wherein when the locking pin components are in the locked position, the locking pin component are engaged with the snap hook to retain the back plate on the frame, and when the locking pin components are in the unlocked position, the locking pin components disengage from the snap hook to allow separation of the back plate from the frame; and
wherein a pair of locking pin components are configured to move closer to each other when driven to the unlocked position.

12. The mobile terminal protective case according to claim 11, wherein the elongated hole has a first end and a second end distributed along a length direction thereof;
when the toggle component is located at the first end of the elongated hole, the locking pin components are in the locked position; and
when the toggle component is located at the second end of the elongated hole, the locking pin components are in the unlocked position.

13. The mobile terminal protective case according to claim 11, wherein the frame is further provided with a relief groove communicating with the slide groove, and a notch of the relief groove faces the accommodating cavity; and
one end of the toggle component is exposed from the elongated hole, and the other end of the toggle component is exposed from the relief groove.

14. The mobile terminal protective case according to claim 11, wherein the back plate comprises a back plate body and a snap hook connected to the back plate body, and when the back plate is assembled to the frame, the back plate body covers the open notch of the slide groove.

15. The mobile terminal protective case according to claim 11, wherein a first stepped surface is provided in the slide groove, and a second stepped surface is provided on the locking pin component; and
a spring is arranged in the slide groove, and both ends of the spring are connected to the first stepped surface and the second stepped surface respectively.

16. The mobile terminal protective case according to claim 15, wherein the spring is compressed when the locking pin components moves toward the unlocked position under an external force.

17. The mobile terminal protective case according to claim 15, wherein the spring is a tension spring, and the tension spring is stretched when the locking pin component moves toward the unlocked position under an external force.

18. The mobile terminal protective case according to claim 11, wherein the frame comprises a first side edge, a second side edge, a third side edge and a fourth side edge connected sequentially end to end, and the pair of locking assemblies are both arranged on the first side edge.

19. The mobile terminal protective case according to claim 18, wherein the first side edge and the third side edge have a same length, the second side edge and the fourth side edge have a same length, and the length of the first side edge is greater than that of the second side edge.

20. The mobile terminal protective case according to claim 18, wherein the back plate has a first end and a second end distributed opposite each other, the second end is inserted into the third side edge along a first set direction, and the first end is engaged and locked with the locking pin component along a second set direction, wherein the first set direction and the second set direction are distributed at an angle.
